(19) United States
(12) Patent Application Publication
(10) Pub. No.: US 2026/0022743 A1
(43) Pub. Date: Jan. 22, 2026

(54) SYSTEMS AND METHODS FOR A DRUM TO DISC BRAKE ADAPTER

(71) Applicant: Capivara Industries LLC, Phoenix, AZ (US)

(72) Inventor: William Jordan, Mesa, AZ (US)

(73) Assignee: Capivara Industries LLC, Phoenix, AZ (US)

(21) Appl. No.: 19/275,691

(22) Filed: Jul. 21, 2025

Related U.S. Application Data
(63) Continuation-in-part of application No. 29/953,283, filed on Jul. 20, 2024.
(60) Provisional application No. 63/673,658, filed on Jul. 19, 2024.

(51) Int. Cl. F16D 55/02; F16D 55/00; F16D 121/14; F16D 125/62

(52) U.S. Cl. CPC F16D 55/02; F16D 2055/0008; F16D 2055/0016; F16D 2121/14; F16D 2125/62; F16D 2250/0084

(57) ABSTRACT

Implementations of a drum to disc brake adapter may comprise a first plurality of mounting lobes surrounding a central opening, the first plurality of mounting lobes located in a first plane on a first side of the adapter and a second plurality of mounting lobes surrounding the central opening, the second plurality of mounting lobes located in a second plane on a second side of the adapter, the second plane parallel to the first plane. The first plurality of mounting lobes is configured to interface with an axle housing and the second plurality of mounting lobes is configured to interface with a disc brake assembly. Each mounting lobe of the first and second pluralities of mounting lobes comprises an opening therethrough. The adapter is configured to preserve use of the emergency or parking brake of a vehicle.

### CROSS-REFERENCE TO RELATED APPLICATIONS

This application claims priority to U.S. application Ser. No. 29/953,283 entitled “Drum to Disc Brake Adapter” to William Jordan, filed on Jul. 20, 2024 and U.S. Provisional Patent Application No. 63/673,658 entitled “Systems and Methods for a Drum to Disc Brake Adapter” to William Jordan, filed on Jul. 20, 2024, the contents of which are hereby incorporated by reference in their entirety.

### BACKGROUND

### 1. Field of the Invention

The present field of the invention generally relates to the systems and methods of an adapter that enables easy installation of modern rear disc brake systems to older models of vehicles that have rear drum brakes while optionally preserving compatibility with the original emergency brake. This invention also generally relates to a disc brake adapter configured with a variable thickness and a variable mounting hole pattern configured to be compatible with a variety of vehicle types, makes, and models.

### 2. Description of Related Art

Existing methods and materials related to older generations of vehicles include conversion kits from rear drum brakes installed on semi-float rear axles that are standard from the factory to disc brakes that require going without the emergency brake that exists in the factory drum brakes or installation of aftermarket emergency brakes on transfer cases or drive shafts.

So as to reduce the complexity and length of the Detailed Specification, and to fully establish the state of the art in certain areas of technology, Applicant(s) herein expressly incorporate(s) by reference all of the following materials identified in each numbered paragraph below.

US Patent Application US20080093180A1 (Pfister) describes disc brake systems retrofittable into existing front wheels without emergency or parking brake systems to replace drum brake assemblies using a mounting ring which is bolted to a vehicle's suspension and where the central aperture of the rotor carrier lines up concentrically with the aperture of the mounting ring to provide room for the axle.

U.S. Pat. No. 4,673,064A (Will) describes a conversion kit where a drum brake is completely removed from the axle and the new rotor is mounted such that the rear surface mounting structure on the core of the hub is aligned with mounting apertures in one end of the bracket plate and with mounting apertures in the flange at the end of the axle and fastening structure that are inserted therethrough for securing them fixedly together and where the bracket is sandwiched between the axle flange and the rotor mounting bracket. The system of Will also requires boring and press fitting which utilizes specialized tools.

Publication GM 14 bolt disk brake conversion from Ruff Stuff (Garage) describes the installation of a caliper bracket on the hub mounting surface of the axle tube, installation of the caliper bracket on the hub mounting surface of the axle tube, a caliper bracket's geometry with the lobes in a different plane than the backing surface, and the installation of the old emergency brake cable onto the new calipers with an optimal approach to installation and necessary measures include welding new tabs in place and modifying the calipers. The system of Ruff Stuff is designed for a full-float axle and the disc brake caliper functions as both the pedal brake and the emergency brake. In the event that either the caliper or brake pad fails, the rear axle braking and emergency braking are entirely imperiled.

U.S. Pat. No. 3,338,339 (Buyze) describes an adapter plate provided for mounting about the spindle of a vehicle for ease of conversion from drum to disk brake where the adapter plate is configured for attaching to a conventional wheel spindle with drum brakes, the adapter plate is secured to the spindle assembly by a plurality of bolts, and a disk brake assembly is mounted on the adapter plate about brake disk.

US Patent Application US20060237267A1 (Brown) describes a pneumatically—or electrically—actuated disk brake where a mounting frame supports the brake caliper and a torque plate secures the mounting plate to the a vehicle axle that is arranged such that fasteners secure the mounting frame to the torque plate and where the caliper mounting frame is located in this embodiment on a torque plate and secured by frame mounting bolts and where the torque plate is configured to be located concentrically about a hub end of a vehicle axle secured to an axle flange by bolts passing through holes.

U.S. Pat. No. 5,316,110A (Null) describes a stationary mounting bracket positioned over the spindle and mounted by suitable fasteners, such as bolts.

U.S. Pat. No. 5,819,886A (Null) describes a trailer brake system that provides an improved disc brake assembly where one end of the stationary mounting bracket is left open so that it may be placed over the axle of the trailer and installed without the need for removing the entire hub assembly.

US Patent Application US20220381303A1 (Mellick-Zock) describes a rear brake conversion assembly that may include a leg-and-foot shaped assembly bracket for operatively associating a dual piston caliber braking component with the rear wheel plate by way of a wheel bracket enabling the conversion from an existing single-piston caliper braking system to an upgraded rear dual piston caliper system which provides better stopping power and less brake fade.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention provides among other things an adapter to enable easy installation of modern rear disc brake systems to older model vehicles that have rear drum brakes while preserving an Original Equipment Manufacturer (OEM) emergency brake system.

Implementation of the present invention may provide for a disc brake adapter system comprising an axle, an adapter, a brake assembly, an emergency brake, and a fastener. Particular aspects of the present invention may include an axle comprising an axle shaft comprising a semi-float rear axle shaft existing on a vehicle originally compatible with a drum brake assembly and a new generation axle shaft and a disc brake axle shaft bearing housing. Particular aspects of the present invention may include a variable thickness adapter comprising an adapter first side further comprising an adapter first side mounting lobe and an adapter second side further comprising an adapter second side mounting lobe. Particular aspects of the present invention may include a fastener configured as a threaded bolt further comprising an adapter first side threaded bolt compatible with an axle housing and an adapter second side bolt compatible with a disc brake axle shaft bearing assembly. Particular aspects of the present invention may optionally include a hardware compatible with the adapter and further comprising a seal such as an O-ring or gasket sealer.

In some implementations, a drum to disc brake adapter may comprise a first plurality of mounting lobes surrounding a central opening, the first plurality of mounting lobes located in a first plane on a first side of the adapter and a second plurality of mounting lobes surrounding the central opening, the second plurality of mounting lobes located in a second plane on a second side of the adapter, the second plane parallel to the first plane. The first plurality of mounting lobes may be configured to interface with an axle housing and the second plurality of mounting lobes is configured to interface with a disc brake assembly.

Particular aspects may comprise one or more of the following features. Each mounting lobe of the first and second pluralities of mounting lobes may comprise an opening therethrough. The openings in the first plurality of mounting lobes may be threaded. The first plurality of mounting lobes may comprise four mounting lobes. The second plurality of mounting lobes may comprise four mounting lobes. The first side of the adapter may be integral to the second side of the adapter. The first side of the adapter may be removable from the second side of the adapter. The adapter may have a thickness of at least one inch. The adapter may have a thickness of about three inches.

Implementations of a method of using a drum to disc brake adapter may comprise disconnecting one or more brake lines and one or more emergency brake cables of a vehicle from a drum brake housing of the vehicle, removing the drum brake housing from an axle housing of the vehicle, fastening a first plurality of mounting lobes of the drum to disc brake adapter to the axle housing, wherein the first plurality of mounting lobes surrounds a central opening and the first plurality of mounting lobes is located in a first plane on a first side of the adapter, and fastening a second plurality of mounting lobes of the drum to disc brake adapter to a disc brake housing, wherein the second plurality of mounting lobes surrounds the central opening and the second plurality of mounting lobes is located in a second plane on a second side of the adapter, the second plane parallel to the first plane.

Particular aspects may comprise one or more of the following features. The method may further comprise installing a new axle shaft and a new axle bearing by fastening the new axle shaft and new axle bearing to the drum to disc brake adapter. The new axle shaft may be longer than an original axle shaft. The method may further comprise attaching an emergency or parking brake cable from the disc brake housing to an emergency or parking brake cable of the vehicle using an emergency brake junction bracket. The method may further comprise installing a brake line extension. The method of may further comprise installing at least one of a new o-ring or a new axle seal onto the drum to disc brake adapter. A spline count of the original axle shaft may be equal to a spline count of the new axle shaft. Each mounting lobe of the first and second pluralities of mounting lobes may comprise an opening therethrough. The openings in the first plurality of mounting lobes may be threaded. The first plurality of mounting lobes and the second plurality of mounting lobes may each comprise four mounting lobes. The first side of the drum to disc brake adapter may be integral to the second side of the drum to disc brake adapter.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 representatively illustrates an exploded view of a drum brake and axle housing.

FIG. 2 representatively illustrates an exploded view of a disc brake and axle housing.

FIG. 3 representatively illustrates a drum brake axle end with a disc brake axle assembly.

FIG. 3A representatively illustrates positioning of a drum to disc brake adapter relative to a drum brake axle end with a disc brake assembly.

FIGS. 4-6 depict embodiments of a drum to disc brake adapter.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Existing kits for upgrading from drum to disc brakes for semi-float axles generally fall into two types. The first eliminates the entire drum brake system and only installs a caliper and rotor for stopping which eliminates the emergency or parking brake function. This results in in a vehicle that is fit for off-road use, but is not legal for daily street driving in the U.S. because U.S. law requires two separate means of applying brakes (normal pedal braking and an emergency or parking brake) to drive on roadways. The second uses an aftermarket part to replace the backing plate of the drum brake assembly with mounts for the calipers used for the disc brakes. This enables the installation of a disc brake and the redundant emergency or parking brake system but requires a great deal of work and specialized tools for the complete disassembly and reassembly of the axle shaft bearing assembly. This also requires moving brake lines to accommodate new caliper locations and changing the location of anti-lock braking system (ABS) sensors. Therefore, this is not an original equipment manufacturer (OEM) design and the installation is complex and requires specialized tools that the average auto garage may not typically have on hand.

Embodiments of the adapter disclosed herein may be used to install a disc brake system onto a rear semi-float axle with a redundant emergency or parking brake system in place of an existing drum brake system having an emergency or parking brake system on a semi-float axle. Embodiments of the adapter may provide the following advantages: 1) upgrade from drum to disc brakes while preserving the OEM emergency brake system; 2) extend the axle width; and 3) increase the diameter of the axle shaft and axle bearings.

It is commonly known that disc brakes are simply better than drum brakes. They brake faster, generate less heat, and are lighter than drums but they also cost more. To keep costs and prices down many OEMs have installed drum brakes on the rear wheels while putting disc brakes on the front wheels where the majority of braking action occurs. This fits in with the OEM design parameters of the vehicle platforms. Users, however, want the increased safety and performance of having disc brakes on all four wheels as found on higher trim levels and other platforms. This desire comes from the experience of drum brakes overheating and failing when descending long hills or when hauling heavy loads and trailers. The emergency or parking brake system on a drum brake is integrated into the drum by having a manually pulled cable use the same brake pads to actuate against the drums to stop the vehicle. It is not a redundant system. If the hydraulic lines of the pedal-actuated system of a drum brake fail the emergency brake system will still function using the same brake pads of the drum brake. If the pads fail from overheating the emergency brake system will also fail.

Embodiments of the adapter disclosed herein may allow for the installation of an OEM designed and built rear disc brake assembly on vehicles that came from the factory with rear drum brakes. An emergency or parking brake is built into the disc brake housing as a mechanical non-hydraulic redundant system. If the disc caliper or pedal system were to fail, the emergency or parking brake can still be used to stop the vehicle. Using OEM hardware is the optimal method of upgrading as spare parts and consumables (brake pads) are available for the platform on which the disc brake assembly was originally installed.

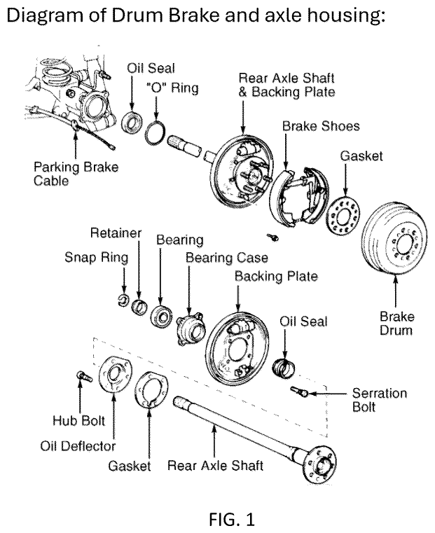

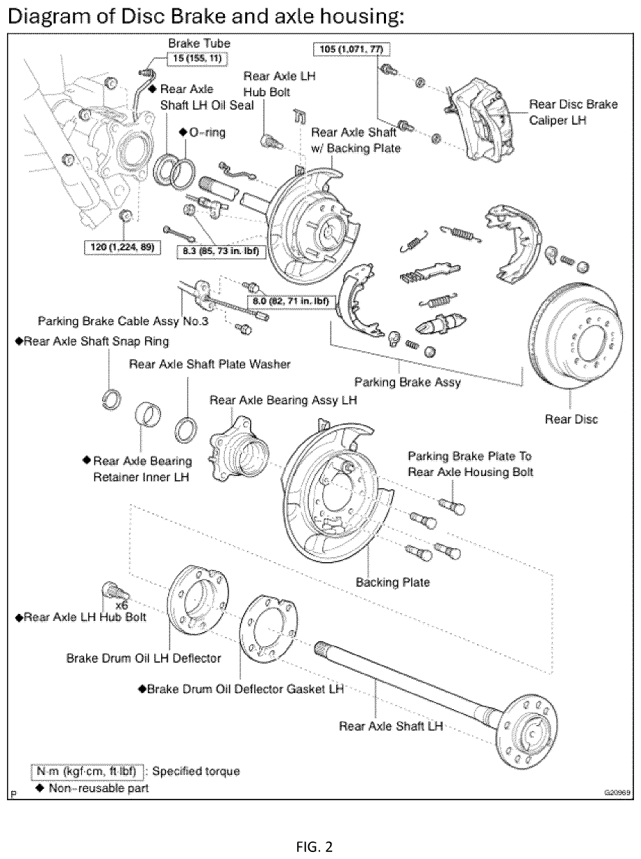

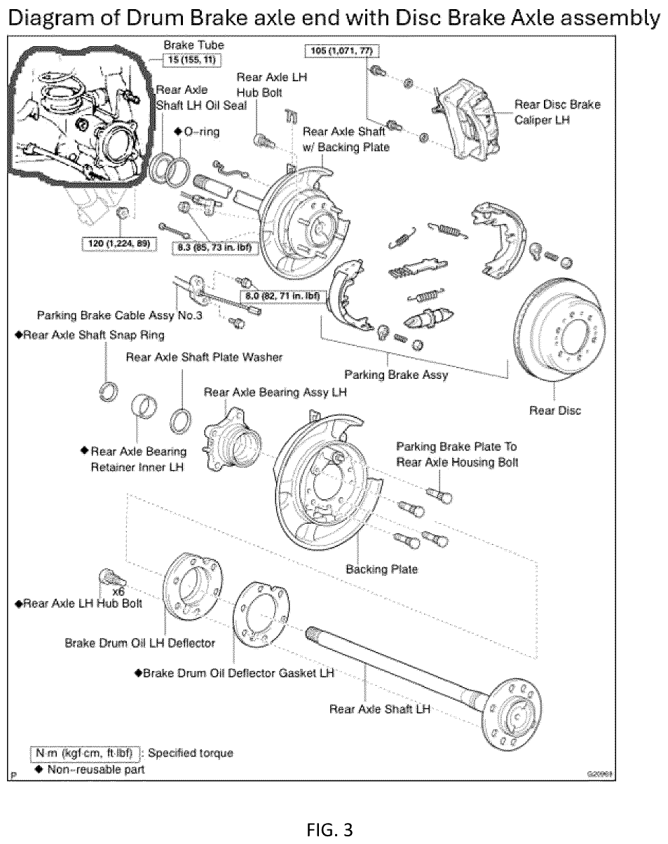

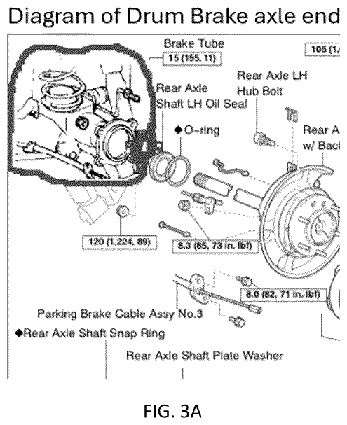

FIGS. 1-3A provide example diagrams of a drum brake and axle housing, a disc brake and axle housing, a drum brake axle end with a disc brake axle assembly, and a drum brake axle end with a disc brake axle assembly showing positioning of a drum to disc brake adapter, respectively.

In one embodiment, the vehicle may comprise any suitable system for conversion of a rear axle brake assembly. In another embodiment, the vehicle may be configured as a truck, a crossover, or a sport utility vehicle. In another embodiment, vehicle may be configured as a specific brand of vehicle such as a Toyota™ vehicle. The vehicle, may however, be configured in any suitable manner to provide a rear brake assembly that requires conversion from a drum brake to a disc brake configuration.

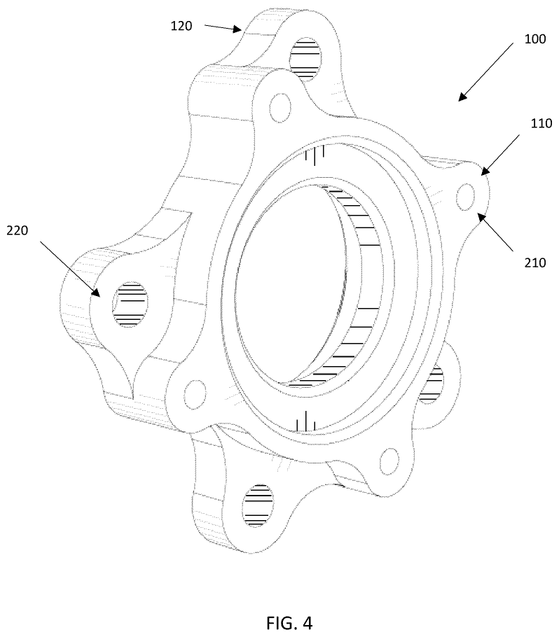

FIGS. 4-6 provide exemplary embodiments of the adapter disclosed herein. It is to be understood that the adapter 100 may comprise any suitable system for connecting an axle housing to a disc brake assembly while optionally preserving a connection to an emergency brake. In some embodiments, adapter 100 may comprise an adapter first side 110 and an adapter second side 120 as shown in FIGS. 4-6.

In one embodiment, the adapter first side 110 may be configured to be compatible with the axle housing such as an adapter first side fastener mounting pattern that provides a connection between the axle housing and the adapter 100. The adapter first side 110 may comprise an adapter first side mounting lobe 210 configured to be compatible with an axle housing mounting pattern such as with four first side mounting lobes 210 as shown in FIGS. 4-6. In some embodiments, the adapter first side mounting lobe 210 may be configured with a through hole, a non-threaded hole, a threaded hole, a tapered hole, a fixed sized hole, a variable sized hole, or other hole compatible with a fastener. The adapter first side mounting lobe 210 may be configured with one hole pattern or a variable number of holes pattern. In another embodiment, the adapter first side mounting lobe 210 may be configured with a symmetric hole pattern or an asymmetric hole pattern.

In some embodiments, the adapter second side 120 may be configured to be compatible with the brake assembly such as an adapter second side fastener mounting pattern that provides a coupling between the brake assembly such as a disc brake assembly and the adapter 100. The adapter second side 120 may comprise an adapter second side mounting lobe 220 configured to be compatible with a disc brake assembly mounting pattern such as with four second side mounting lobes 220 as shown in FIGS. 4-6. The adapter second side mounting lobe 220 may be configured with a through hole, a non-threaded hole, a threaded hole, a tapered hole, a fixed sized hole, a variable sized hole, or other hole compatible with the fastener. In some embodiments, the adapter second side mounting lobe 220 may be configured with one hole pattern or a variable number of holes pattern. In some embodiments, the adapter second side mounting lobe 220 may be configured with a symmetric hole pattern or an asymmetric hold pattern.

In one application, the adapter 100 may be configured as a variable thickness adapter such as an adapter 100 configured with a thickness selected to maintain functionality of the emergency braking system. In another application, the adapter 100 may be configured as a variable thickness adapter such as an adapter 100 configured with a thickness of about zero to one inches thick, about one to three inches thick, about one to six inches thick, or more than about six inches thick.

In another application, the adapter 100 may be configured with a thickness such that when more than on adapter 100 is installed on the vehicle the thickness of each adapter 100 is selected to maintain functionality of the emergency braking system such as an adapter 100 configured be about three inches in thickness resulting in an overall increase in width of about six inches from the original width of the axle and brake assembly when two adapters 100 are installed such as one adapter 100 installed on the left rear axle and one adapter 100 installed on the right rear axle.

In another application, the adapter 100 may be configured with a customizable thickness correlated to a specific vehicle configuration such that when more than one adapter 100 is installed on a specific vehicle the thickness of each adapter 100 is selected to maintain functionality of the emergency braking system such as an adapter 100 configured as about 3 inches in thickness for a specific brand, make, and model truck.

The adapter 100, may however, be configured in any suitable manner to provide attachment to a vehicle, an axle, a brake assembly, a disc brake assembly not originally configured for the vehicle, an emergency brake, a tire, or other components of the system.

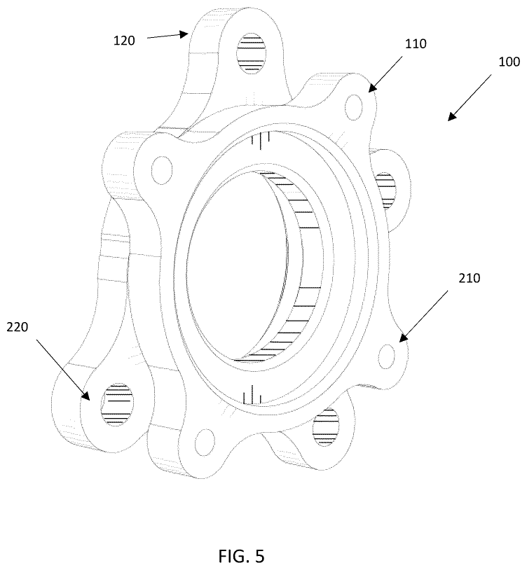

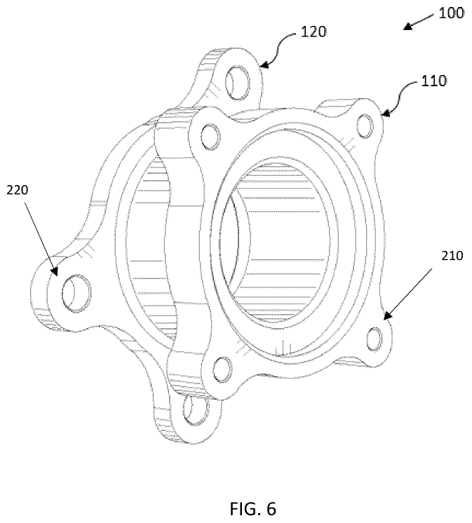

In some embodiments, as shown in FIGS. 4-5, the adapter first side 110 and the adapter second side 120 may be formed as integral to one another and in other embodiments such as depicted in FIG. 6, the adapter first side 110 and the adapter second side 120 may be separate components.

In some embodiments, additional hardware may be used in conjunction with the adapter. The hardware may comprise any suitable system for optionally improving the connection between the adapter and the axle housing or the adapter and the brake assembly. In some embodiments, the hardware may be configured as a seal such as a gasket sealer or an o-ring. In some embodiments, the hardware may be configured as a seal compatible with the adapter first side 110 such as a first side gasket sealer or first side o-ring. In another embodiment, the hardware may be configured as a seal compatible with the adapter second side 120 such as a second side gasket sealer or second side o-ring. In another embodiment, the hardware may comprise a first side o-ring and a first side gasket sealer. In another embodiment, the hardware may comprise a second side o-ring and a second side gasket sealer. In another embodiment, the hardware may comprise a first side o-ring, a first side gasket sealer, a second side o-ring, and a second side gasket sealer. The hardware, may however, be configured in any suitable manner to provide attachment to or connection between a vehicle, an axle, an adapter, a brake assembly, a tire, or other components of the system.

The system according to various aspects of an embodiment of the invention provides for conversion of an existing rear drum brake assembly to a new rear disc brake assembly while optionally preserving the existing emergency brake by jacking up the vehicle, removing a tire, and disconnecting any brake lines and any emergency brake cable from the drum brake housing. The drum brake housing including the axle shaft and bearing housing is then removed from the axle housing. The adapter is then bolted to the axle housing. New o-rings and an axle seal may optionally be installed onto the adapter. The next step is to install the disc brake housing, a new axle shaft and a new axle bearing by fastening them to the adapter with a suitable fastener such as a bolt. The newly installed semi-float axle must be longer than the original axle due to the thickness of the adapter and any difference in thickness of the axle bearing assemblies. The axle shaft spline count must also match the spline count of the removed axle. The wheel lug patten on the new axle also preferably matches the lug pattern of the removed axle unless a change in lug pattern is desired. The next step is to attach the emergency or parking brake cables from the disc brake housing to the vehicle's emergency or parking brake cable using an emergency brake junction bracket. The hydraulic brake line is then attached and the hydraulic brake system is bled. In some applications, a brake line extension may be needed due to the thickness of the adapter and/or past repairs or modifications to the vehicle's brake line system.

It should be noted that the adapter embodiments shown in the figures depict bolt hole patterns required for drum brake housings from the Toyota Tacoma/Hilux platform and disc brake housings from the Toyota 4runner/Surf platform, however the adapter may comprise any other bolt hole patterns for other makes and models of vehicles. Embodiments of the adapter may also have varying widths to increase the width of the axle for a wider wheelbase. In this instance, longer aftermarket cut-to-fit axle shafts may be used having the same spline count as the removed axle. Other bolt hole patterns for other platforms and OEMs can also be used provided that the axle spline count matches the differential in the axle housing. The bolt hole patterns on each side of the adapter may also be threaded or non-threaded depending on which vehicle platforms are being used.

In places where the description above refers to particular implementations of systems and methods for a disc brake adapter system, it should be readily apparent that a number of modifications may be made without departing from the spirit thereof and that these implementations may be applied to other to systems and methods for a disc brake adapter system.

I claim:

1. A drum to disc brake adapter comprising:
a first plurality of mounting lobes surrounding a central opening, the first plurality of mounting lobes located in a first plane on a first side of the adapter;
a second plurality of mounting lobes surrounding the central opening, the second plurality of mounting lobes located in a second plane on a second side of the adapter, the second plane parallel to the first plane;
wherein the first plurality of mounting lobes is configured to interface with an axle housing and the second plurality of mounting lobes is configured to interface with a disc brake assembly.

2. The adapter of claim 1, wherein each mounting lobe of the first and second pluralities of mounting lobes comprises an opening therethrough.

3. The adapter of claim 2, wherein the openings in the first plurality of mounting lobes is threaded.

4. The adapter of claim 1, wherein the first plurality of mounting lobes comprises four mounting lobes.

5. The adapter of claim 1, wherein the second plurality of mounting lobes comprises four mounting lobes.

6. The adapter of claim 1, wherein the first side of the adapter is integral to the second side of the adapter.

7. The adapter of claim 1, wherein the first side of the adapter is removable from the second side of the adapter.

8. The adapter of claim 1, wherein the adapter has a thickness of at least one inch.

9. The adapter of claim 1, wherein the adapter has a thickness of about three inches.

10. A method of using a drum to disc brake adapter, the method comprising:
disconnecting one or more brake lines and one or more emergency brake cables of a vehicle from a drum brake housing of the vehicle;
removing the drum brake housing from an axle housing of the vehicle;
fastening a first plurality of mounting lobes of the drum to disc brake adapter to the axle housing, wherein the first plurality of mounting lobes surrounds a central opening and the first plurality of mounting lobes is located in a first plane on a first side of the adapter; and
fastening a second plurality of mounting lobes of the drum to disc brake adapter to a disc brake housing, wherein the second plurality of mounting lobes surrounds the central opening and the second plurality of mounting lobes is located in a second plane on a second side of the adapter, the second plane parallel to the first plane.

11. The method of claim 10, further comprising installing a new axle shaft and a new axle bearing by fastening the new axle shaft and new axle bearing to the drum to disc brake adapter.

12. The method of claim 11, wherein the new axle shaft is longer than an original axle shaft.

13. The method of claim 10, further comprising attaching an emergency or parking brake cable from the disc brake housing to an emergency or parking brake cable of the vehicle using an emergency brake junction bracket.

14. The method of claim 13, further comprising installing a brake line extension.

15. The method of claim 10, further comprising installing at least one of a new o-ring or a new axle seal onto the drum to disc brake adapter.

16. The method of claim 12, wherein a spline count of the original axle shaft is equal to a spline count of the new axle shaft.

17. The method of claim 10, wherein each mounting lobe of the first and second pluralities of mounting lobes comprises an opening therethrough.

18. The method of claim 17, wherein the openings in the first plurality of mounting lobes is threaded.

19. The method of claim 10, wherein the first plurality of mounting lobes and the second plurality of mounting lobes each comprise four mounting lobes.

20. The method of claim 10, wherein the first side of the drum to disc brake adapter is integral to the second side of the drum to disc brake adapter.
